(19) United States
(12) Patent Application Publication
(10) Pub. No.: US 2025/0219746 A1
(43) Pub. Date: Jul. 3, 2025

(54) PATHLOSS CALIBRATION METHOD USED FOR A RADIO-FREQUENCY COMMUNICATION DEVICE

(71) Applicant: MEDIATEK INC., Hsin-Chu (TW)

(72) Inventors: Sin-Han Yang, Hsinchu City (TW); Bo-Yu Lin, Hsinchu City (TW)

(73) Assignee: MEDIATEK INC., Hsin-Chu (TW)

(21) Appl. No.: 18/399,597

(22) Filed: Dec. 28, 2023

(51) Int. Cl. H04B 17/309; H04B 17/21

(52) U.S. Cl. CPC H04B 17/347; H04B 17/21

(57) ABSTRACT

A pathloss calibration method used for a radio-frequency communication device can include defining m×n conditions according to m frequency bands and n power gears, obtaining x base pathloss values under x conditions of the m×n conditions on a first route of the radio-frequency communication device, obtaining y anchor pathloss values under y conditions of the m×n conditions on a second route of the radio-frequency communication device, generating y offset values according to the y anchor pathloss values and y base pathloss values of the x base pathloss values where the y base pathloss values are obtained under the y conditions, and generating z anchor pathloss values on the second route according to the y offset values and the x base pathloss values.

### BACKGROUND

In the field of communication technology, radio frequency circuits have been widely used. A common architecture can include a front-end circuit and a radio frequency circuit. After the front-end circuit amplifies a signal, the radio frequency circuit can be used to perform amplification, mixing, and/or filtering to convert the signal received by an antenna into an internal signal.

When using a radio frequency circuit, the signal paths can be corresponding to a plurality of frequency bands and amplification gears related to a plurality of operating conditions. However, in order to obtain the pathloss values corresponding to the paths in a plurality of conditions, it is necessary to use external instruments to perform a large number of measurements, making it difficult to reduce the measurement time and instrument requirements. Hence, a better solution is still in need for obtaining pathloss values of different conditions.

### SUMMARY

An embodiment provides a pathloss calibration method used for a radio-frequency communication device. The pathloss calibration method can include defining m×n conditions according to m frequency bands and n power gears, obtaining x base pathloss values under x conditions of the m×n conditions on a first route of the radio-frequency communication device, obtaining y anchor pathloss values under y conditions of the m×n conditions on a second route of the radio-frequency communication device, generating y offset values according to the y anchor pathloss values and y base pathloss values of the x base pathloss values where the y base pathloss values are obtained under the y conditions, and generating z anchor pathloss values on the second route according to the y offset values and the x base pathloss values.

Another embodiment provides a pathloss calibration method used for a radio-frequency communication device. The pathloss calibration method can include defining m×n conditions according to m frequency bands and n power gears, using an external test device to obtain a first base pathloss value of a predetermined frequency band of the m frequency bands on a first route of the radio-frequency communication device under a first condition of the m×n conditions where the first condition is corresponding to the predetermined frequency band, using the external test device to obtain a first anchor pathloss value of the predetermined frequency band on a second route of the radio-frequency communication device under the first condition, generating a first difference between the first base pathloss value and the first anchor pathloss value, using an internal test-tone circuit to obtain a second base pathloss value and a second anchor pathloss value of the predetermined frequency band on the first route and the second route under the first condition, generating a second difference between the second base pathloss value and the second base pathloss value, using the internal test-tone circuit to obtain a third base pathloss value and a third anchor pathloss value of a target frequency band on the first route and the second route under a second condition of the m×n conditions, generating a third difference between the third base pathloss value and the third anchor pathloss value, generating a calibration value according to the first difference, the second difference and the third difference, using the external test device to obtain a reference base pathloss value of the target frequency band on the first route under the second condition, and generating a calibrated anchor pathloss value of the target frequency band according to the reference base pathloss value and the calibration value. The external test device is not a part of the radio-frequency communication device, and the internal test-tone circuit is disposed in the radio-frequency communication device.

Another embodiment provides a pathloss calibration device including a test device and a processing device. The test device is used to define m×n conditions according to m frequency bands and n power gears, obtain x base pathloss values under x conditions of the m×n conditions on a first route of a radio-frequency communication device, and obtain y anchor pathloss values under y conditions of the m×n conditions on a second route of the radio-frequency communication device. The processing device is used to generate y offset values according to the y anchor pathloss values and y base pathloss values of the x base pathloss values where the y base pathloss values are obtained under the y conditions, and generate z anchor pathloss values on the second route according to the y offset values and the x base pathloss values.

Another embodiment provides a pathloss calibration device including an external test device, an internal test-tone circuit and a processing device. The external test device is used to measure a first base pathloss value of a predetermined frequency band of the m frequency bands on a first route of a radio-frequency communication device under a first condition of m×n conditions where the first condition is corresponding to the predetermined frequency band, and the m×n conditions are defined according to m frequency bands and n power gears, measure a first anchor pathloss value of the predetermined frequency band on a second route of the radio-frequency communication device under the first condition, and measure a reference base pathloss value of a target frequency band on the first route under a second condition of the m×n conditions. The internal test-tone circuit is used to measure a second base pathloss value and a second anchor pathloss value of the predetermined frequency band on the first route and the second route under the first condition, and measure a third base pathloss value and a third anchor pathloss value of the target frequency band on the first route and the second route under the second condition. The processing device is used to generate a first difference between the first base pathloss value and the first anchor pathloss value, generate a second difference between the second base pathloss value and the second base pathloss value, generate a third difference between the third base pathloss value and the third anchor pathloss value, generate a calibration value according to the first difference, the second difference and the third difference, and generate a calibrated anchor pathloss value of the target frequency band according to the reference base pathloss value and the calibration value. The external test device is not a part of the radio-frequency communication device, and the internal test-tone circuit is disposed in the radio-frequency communication device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a radio-frequency communication device according to an embodiment.

FIG. 2 illustrates m×n conditions of the first route in FIG. 1.

FIG. 3 illustrates m×n conditions of the second route in FIG. 1.

FIG. 4 illustrates a flowchart of a pathloss calibration method for generating the anchor pathloss values of the second route in FIG. 1.

FIG. 5 illustrates a radio-frequency communication device according to another embodiment.

FIG. 6 is a flowchart of a pathloss calibration method for generating anchor pathloss values of the third route in FIG. 5.

FIG. 7 illustrates a radio-frequency communication device according to another embodiment.

FIG. 8 illustrates m×n conditions of the second route in FIG. 7.

FIG. 9 illustrates a radio-frequency communication device according to another embodiment.

FIG. 10 illustrates m×n conditions of the second route R2 in FIG. 9.

FIG. 11 illustrates a radio-frequency communication device according to another embodiment.

FIG. 12 is a flowchart of a pathloss calibration method used for the radio-frequency communication device in FIG. 11.

FIG. 13 illustrates a curve corresponding to gains of the first route and a curve corresponding to gains of the second route obtained using the external test device in FIG. 11.

FIG. 14 illustrates a curve corresponding to gains of the first route and a curve corresponding to gains of the second route obtained using the internal test-tone circuit in FIG. 11.

FIG. 15 illustrates a pathloss calibration device used to perform the pathloss calibration method of FIG. 4.

FIG. 16 illustrates a calibration stage structure according to an embodiment.

FIG. 17 illustrates a pathloss calibration device used to perform the pathloss calibration method in FIG. 12.

### DETAILED DESCRIPTION

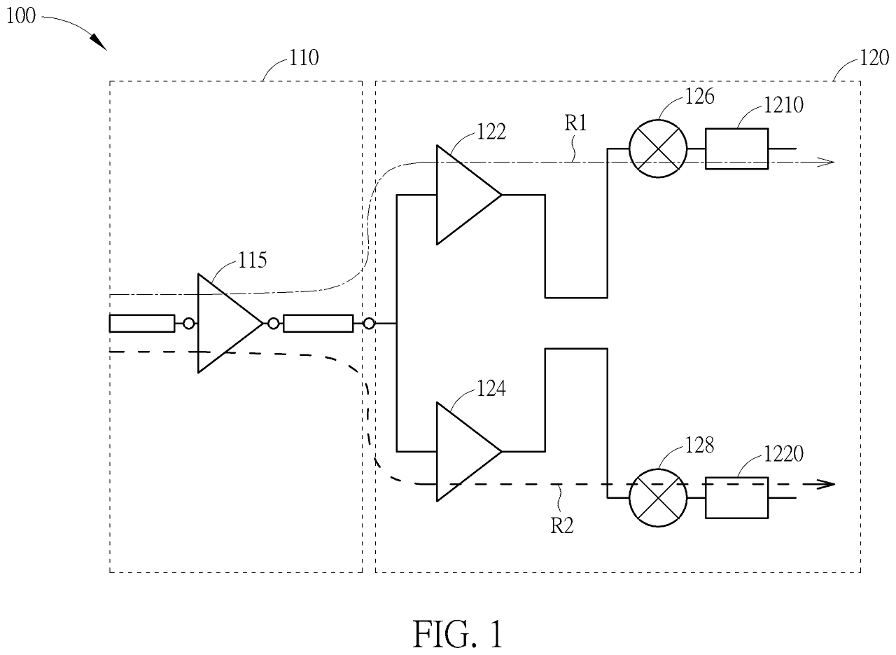

FIG. 1 illustrates a radio-frequency communication device 100 according to an embodiment. The radio-frequency communication device 100 can include a front-end 110 and a radio-frequency circuit 120. The radio-frequency circuit 120 can be embedded in an integrated circuit (IC). The front-end 110 can include an amplifier 115. The radio-frequency circuit 120 can include an amplifier 122, an amplifier 124, a mixer 126, a mixer 128, a processing circuit 1210 and a processing circuit 1220. Each of the processing circuit 1210 and the processing circuit 1220 may include a filter.

A first route R1 can pass through the amplifier 115, the amplifier 122, the mixer 126 and the processing circuit 1210. A second route R2 can pass through the amplifier 115, the amplifier 124, the mixer 128 and the processing circuit 1220.

Signals can be transmitted through the first route R1 and the second route R2. When a signal is transmitted through the first route R1 or the second route R2, the signal can be corresponding to one of the m frequency bands and one of the n power gears of the amplifiers 115, 122 and 124. Hence, a signal can be transmitted in one of m×n conditions defined according to the m frequency bands and the n power gears.

Here, the m frequency bands can be m sub-bands of m sub-channels. For example, LTE (long term evolution) standard can be corresponding to a set of bands (B1, B2 . . . ), the band B1 can be divided into m sub-bands for calibration, and the m sub-bands can be the mentioned m frequency bands.

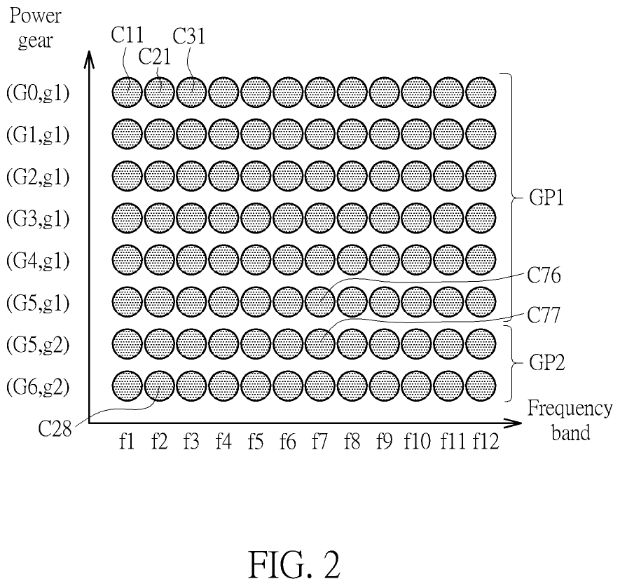

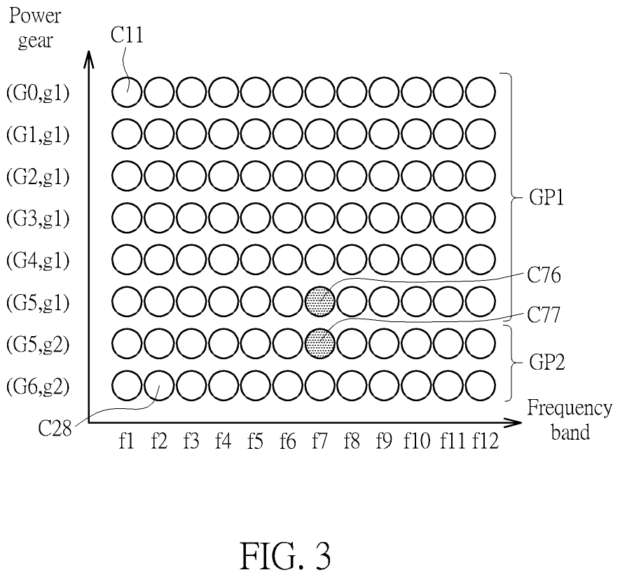

FIG. 2 illustrates m×n conditions of the first route R1 in FIG. 1. FIG. 3 illustrates m×n conditions of the second route R2 in FIG. 1. In FIG. 2 and FIG. 3, the m×n conditions can be corresponding to m frequency bands and the n power gears of the amplifiers in FIG. 1. Each circle in FIG. 2 and FIG. 3 can be corresponding to one condition. In FIG. 2 and FIG. 3, a condition of an αth frequency band and a βth power gear can be expressed as Cαβ.

In FIG. 2 and FIG. 3, m and n are exemplified by 12 and 8 respectively. Power gears G0 to G6 are of the amplifier 115, and power gears g1 and g2 are of each of the amplifiers 122 and 124. The m frequency bands can include frequency bands f1 to f12. The n power gears can include power gears (G0, g1), (G1, g1), (G2, g1), (G3, g1), (G4, g1), (G5, g1), (G5, g2) and (G6, g2).

In FIG. 1 to FIG. 3, the first route R1 can be a “base route”, and the second route R2 can be an “anchor route”. Regarding the first route R1 (i.e. base route), x base pathloss values under x conditions of the m×n conditions (e.g. 12×8 conditions) can be generated as known base pathloss values. For example, the x base pathloss values under the x conditions of the m×n conditions can be measured using an external test device.

Regarding the second route R2 (i.e. anchor route), y base pathloss values under y conditions of the m×n conditions (e.g. 12×8 conditions) can be generated as known anchor pathloss values. For example, the y base pathloss values under the y conditions of the m×n conditions can be measured using the external test device. Here, the parameters m, n, x and y can be integers larger than zero, x≤m×n, and x>y.

For example, if m is 12, n is 8, then m×n is 96, x can be 96, and y can be 2. Hence, for the first route R1 (i.e. base route), the pathloss values under x conditions (e.g. 96 conditions) can be measured. For the second route R2 (i.e. anchor route), the pathloss values under y conditions (e.g. 2 conditions) can be measured. For example, the y conditions (e.g. 2 conditions) can be the conditions C76 and C77 in FIG. 3.

In FIG. 1 to FIG. 3, the base pathloss values of the conditions C76 and C77 of the first route R1 (i.e. base route) can be expressed as P76b and P77b respectively. The anchor pathloss values of the conditions C76 and C77 of the second route R2 (i.e. anchor route) can be expressed as P76a and P77a respectively. Hence, y offset values (expressed as offset_g1 and offset_g2) can be generated according to y anchor pathloss values (e.g. P76a and P77a) and y base pathloss values (e.g. P76b and P77b). It can be expressed as:

$$offset\_g1 = P 76 a - P 76 b ; and \qquad eq - 1$$

$$offset\_g2 = P 77 a - P 77 b . \qquad eq - 2$$

The offset value offset_g1 can be corresponding to the first group GP1 in FIG. 2 and FIG. 3, and the first group GP1 can be corresponding to the power gear g1 of the amplifiers 122 and 124 in FIG. 1. The offset value offset_g2 can be corresponding to the second group GP2 in FIG. 2 and FIG. 3, and the second group GP2 can be corresponding to the power gear g2 of the amplifiers 122 and 124 in FIG. 1.

After generating the offset values offset_g1 and offset_g2, the offset values offset_g1 and offset_g2 can be used to generate the anchor path loss values of z conditions (e.g. 94 conditions except C76 and C77).

For example, a base pathloss value P11b of the first route R1 in the condition C11 can be a known value measured using the external test device. The anchor pathloss value P11a of the second route R2 of the condition C11 can be derived according to base pathloss value P11b and the offset values offset_g1. It can be expressed as:

$$P 11 a = P 11 b + offset\_g1 . \qquad eq - 3$$

Likewise, other anchor pathloss values corresponding to the first group GP1 of the anchor path (e.g. second route R2) can be generated using the corresponding known base pathloss values and the offset_g1.

As for the anchor pathloss values of the second group GP2, they can be generated using the offset values offset_g2. In FIG. 1 to FIG. 3, a base pathloss value P28b of the first route R1 in the condition C28 can be a known value measured using the external test device. The anchor pathloss value P28a of the second route R2 in the condition C28 can be derived according to base pathloss value P28b and the offset values offset_g2. It can be expressed as

$$P 28 a = P 28 b + offset\_g2 . \qquad eq - 4$$

Likewise, other anchor pathloss values corresponding to the second group GP2 of the anchor path (e.g. second route R2) can be generated using the corresponding known base pathloss values and the offset_g2.

As mentioned in FIG. 1 to FIG. 3, only y anchor pathloss values (e.g. 2 pathloss values) should be measured, and other anchor pathloss values (e.g. 94 pathloss values) can be derived according to offset values (e.g. offset_g1 and offset_g2) and known base pathloss values.

Since only y anchor pathloss values (e.g. 2 pathloss values of the second rout R2) instead of m×n anchor pathloss values (e.g. 96 pathloss values of the second route R2) should be measured using the test device, time and cost of testing are effectively reduced.

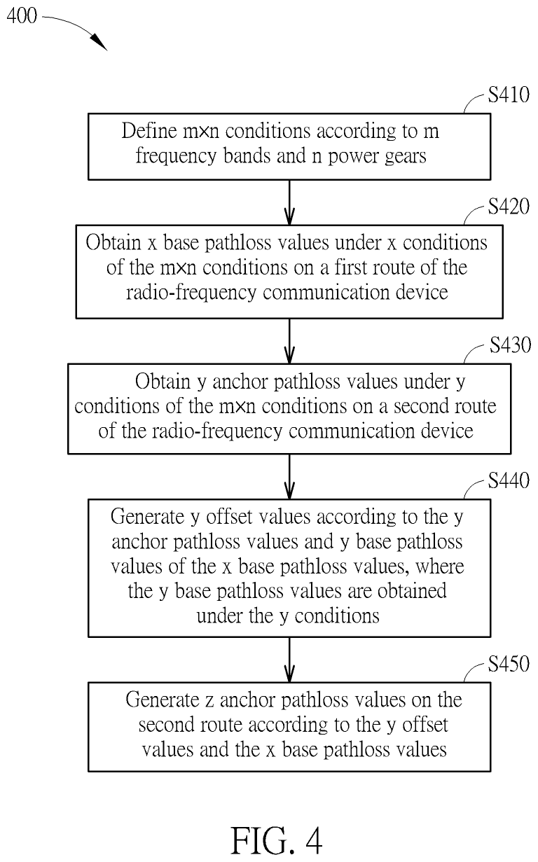

FIG. 4 illustrates a flowchart of a pathloss calibration method 400 according to an embodiment. The pathloss calibration method 400 can include the following steps.

Step S410: define m×n conditions according to m frequency bands and n power gears;

Step S420: obtain x base pathloss values under x conditions of the m×n conditions on a first route of the radio-frequency communication device;

Step S430: obtain y anchor pathloss values under y conditions of the m×n conditions on a second route of the radio-frequency communication device;

Step S440: generate y offset values according to the y anchor pathloss values and y base pathloss values of the x base pathloss values, where the y base pathloss values are obtained under the y conditions; and

Step S450: generate z anchor pathloss values on the second route according to the y offset values and the x base pathloss values.

In FIG. 4, the parameters m, n, x, y and z are integers larger than zero, x≤m×n, and x>y. In the example of FIG. 1 to FIG. 3, m is 12, n is 8, and m×n is 96.

In Step S420, x can be m×n. If x is smaller than m×n, for example, other (m×n−x) base pathloss values can be generated according to the known x base pathloss values using interpolation or extrapolation. For example, a base pathloss value of the condition C21 in FIG. 2 may be generated according to base pathloss values of the conditions C11 and C31 in FIG. 2 using interpolation. For example, it can expressed as P21b=(P11b+P31b)/2.

In Step S450, the z anchor pathloss values may be the (m×n−y) anchor pathloss values generated using the known x base pathloss values and the y offset values. For example, in FIG. 1 to FIG. 3, the z anchor pathloss values generated in Step S450 can include 94 anchor pathloss values except the anchor pathloss values P76a and P77a (e.g. the y anchor pathloss values in Step S430) of the conditions C76 and C77.

In FIG. 4, each of the y offset values can be generated by subtracting a corresponding base pathloss value of the x base pathloss value from a corresponding anchor pathloss value of the y anchor pathloss values. The corresponding base pathloss value and the corresponding anchor pathloss value are obtained under a same condition of the m×n conditions. For example, as shown in the abovementioned equations eq-1 and eq-2, the y offset values can be generated. In FIG. 1 to FIG. 3, y can be exemplified by 2.

As mentioned in FIG. 1 to FIG. 4, the radio-frequency communication device 100 can include the amplifier 122 on the first route R1, and the amplifier 124 on the second route R2. The amplifier 122 and the amplifier 124 can be operated in a first power gear (e.g. power gear g1) in a first condition (e.g. condition C76) of the y conditions (e.g. conditions C76 and C77). The amplifier 122 and the amplifier 124 can be operated in a second power gear (e.g. power gear g2) in a second condition (e.g. condition C77) of the y conditions (e.g. conditions C76 and C77).

The first offset value (e.g. offset value offset_g1) related to the first condition (e.g. condition C76) can be used to generate a first group of the z anchor pathloss values related to the first power gear (e.g. power gear g1), such as the anchor pathloss values in the first group GP1 except the anchor pathloss value P76a.

The second offset value (e.g. offset value offset_g2) related to the second condition (e.g. condition C77) can be used to generate a second group of the z anchor pathloss values related to the second power gear (e.g. power gear g2), such as the anchor pathloss values in the second group GP2 except the anchor pathloss value P77a.

In FIG. 1 to FIG. 4, the radio-frequency communication device 100 can include a low noise amplifier (e.g. the amplifier 115) on the first route R1 and the second route R2. The low noise amplifier can have k gears (e.g. G0 to G6) corresponding to the n power gears (e.g. power gears (G0, g1), (G1, g1), (G2, g1), (G3, g1), (G4, g1), (G5, g1), (G5, g2) and (G6, g2) in FIG. 2 and FIG. 3), where k is an integer larger than zero.

In FIG. 1 to FIG. 4, each of the z anchor pathloss values can be generated by adding a corresponding offset value (e.g. offset value offset_g1 or offset_g2) of the y offset values to a corresponding base pathloss value of the x base pathloss values. The generated anchor pathloss value and the corresponding base pathloss value can be related to a same condition of the m×n conditions. For example, as described in the equations eq-3 and eq-4, an anchor pathloss value can be generated according to corresponding offset value and base pathloss value.

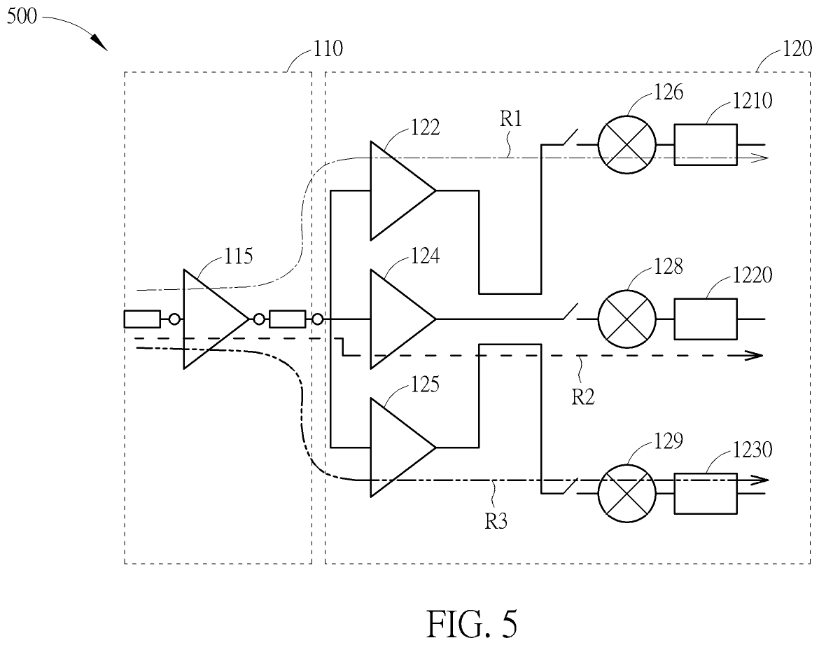

FIG. 5 illustrates a radio-frequency communication device 500 according to another embodiment. Compared to the radio-frequency communication device 100 in FIG. 1, the radio-frequency communication device 500 can further include an amplifier 125, a mixer 129, and a processing circuit 1230. A third route R3 can pass through the amplifier 115, the amplifier 125, the mixer 129 and the processing circuit 1230. Similar to FIG. 1 to FIG. 3, the third route R3 can be another anchor route.

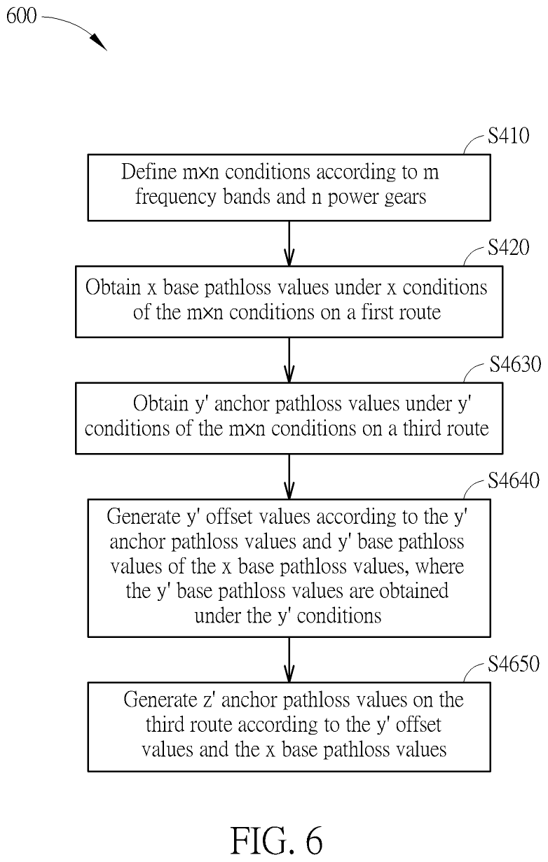

Similar to FIG. 1 to FIG. 4, regarding the first route R1 (i.e. base route) and the third route R3 (i.e. anchor route), z′ anchor pathloss values of the third route R3 can be generated with the following steps in FIG. 6. FIG. 6 is a flowchart of a pathloss calibration method 600 for generating anchor pathloss values of the third route R3 in FIG. 5. The pathloss calibration method 600 can include the following steps.

Step S410: define m×n conditions according to m frequency bands and n power gears;

Step S420: obtain x base pathloss values under x conditions of the m×n conditions on a first route R1 of the radio-frequency communication device 500;

Step S4630: obtain y′ anchor pathloss values under y′ conditions of the m×n conditions on a third route R3 of the radio-frequency communication device 500;

Step S4640: generate y′ offset values according to the y′ anchor pathloss values and y′ base pathloss values of the x base pathloss values, where the y′ base pathloss values are obtained under the y′ conditions; and

Step S4650: generate z′ anchor pathloss values on the third route R3 according to the y′ offset values and the x base pathloss values.

In FIG. 5 and FIG. 6, the parameters y′ and z′ are integers larger than zero, and x>y′. Steps S410 and S420 in FIG. 6 can be similar to Steps S410 and S420 in FIG. 4. Steps S4630 to S4650 can be similar to Steps S430 to S450 in FIG. 4. In FIG. 5 and FIG. 6, the z′ anchor pathloss values of the third route R3 can be the m×n anchor pathloss values except the y′ known anchor pathloss values generated in Step S4630.

In FIG. 5 and FIG. 6, signals transmitted through the third route R3 can be corresponding to m×n anchor pathloss values. A part of the m×n anchor pathloss values of the third route R3 (e.g. z′ anchor pathloss values in Step S4650) can be generated according to corresponding base pathloss values and offset values without using a test device to measure all of the m×n anchor pathloss values of the third route R3. Hence, time and cost of testing are effectively reduced.

In FIG. 1 to FIG. 6, an external test device can be used to obtain the x base pathloss values of the first route R1, the y anchor pathloss values of the second route R2 and the y′ anchor pathloss values of the third route R3. The external test device is not a part of the radio-frequency communication devices 100 and 500.

In FIG. 1 and FIG. 5, the amplifier 115 can be a low noise amplifier (LNA), and each of the amplifiers 122, 124 and 125 can be a transconductance (gm) amplifier.

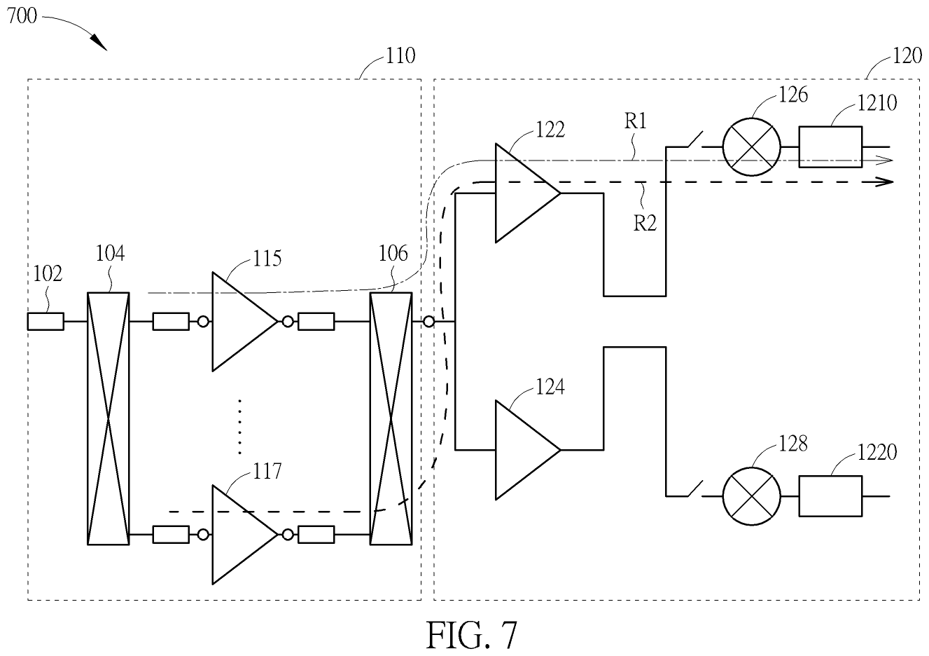

FIG. 7 illustrates a radio-frequency communication device 700 according to another embodiment. The radio-frequency communication device 700 can include a front end circuit 110 and a radio-frequency circuit 120. The front end circuit 110 can include a port 102, a circuit 104, amplifiers 115 and 117 and a circuit 106. The radio-frequency circuit 120 can include an amplifier 122, a mixer 126 and a processing circuit 1210. In FIG. 7, the circuits 104 and 106 can include multiplexer circuits used to arrange the route of transmitting signals. The amplifiers 115 and 122 can be on the first route R1. The amplifiers 117 and 122 can be on the second route R2. The base pathloss values of the first route R1 can be obtained, a part of the anchor pathloss values of the second route R2 can be obtained, and other anchor pathloss values of the second route R2 can be derived according to known pathloss values of the first route R1 and the second route R2 with the pathloss calibration method 400 in FIG. 4. In FIG. 7, the amplifiers 115 and 117 can be low noise amplifiers (LNAs). The amplifier 122 can be transconductance (gm) amplifier.

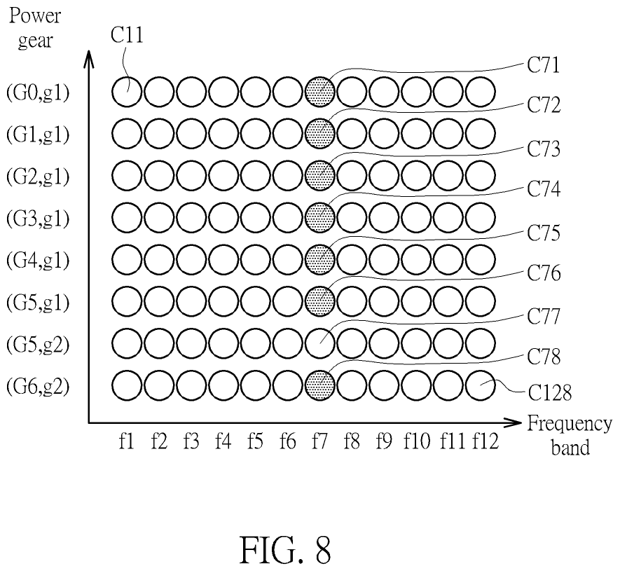

FIG. 8 illustrates m×n conditions of the second route R2 in FIG. 7. In FIG. 8, a condition of an αth frequency band and a βth power gear can be expressed as Cap. For the first route R1 in FIG. 7, all base pathloss values of C11 to C128 can be obtained, for example, measured with an external testing device, as the x base pathloss values in Step S420. For the second route R2 in FIG. 7, the anchor pathloss values of the frequency band f7 can be obtained, for example, measured with an external testing device as the y anchor pathloss values in the Step S430. For example, the anchor pathloss values of the conditions C71, C72, C73, C74, C75, C76 and C78 can be measured as the y anchor pathloss values in Step S430. Since the first route R1 and the second route R2 share the same path in the radio-frequency circuit 120, the y anchor pathloss values in Step S430 can be of a same frequency band (e.g. the frequency band f7). Then, other anchor pathloss values can be derived with the known base pathloss values and anchor pathloss values with the flow of FIG. 4.

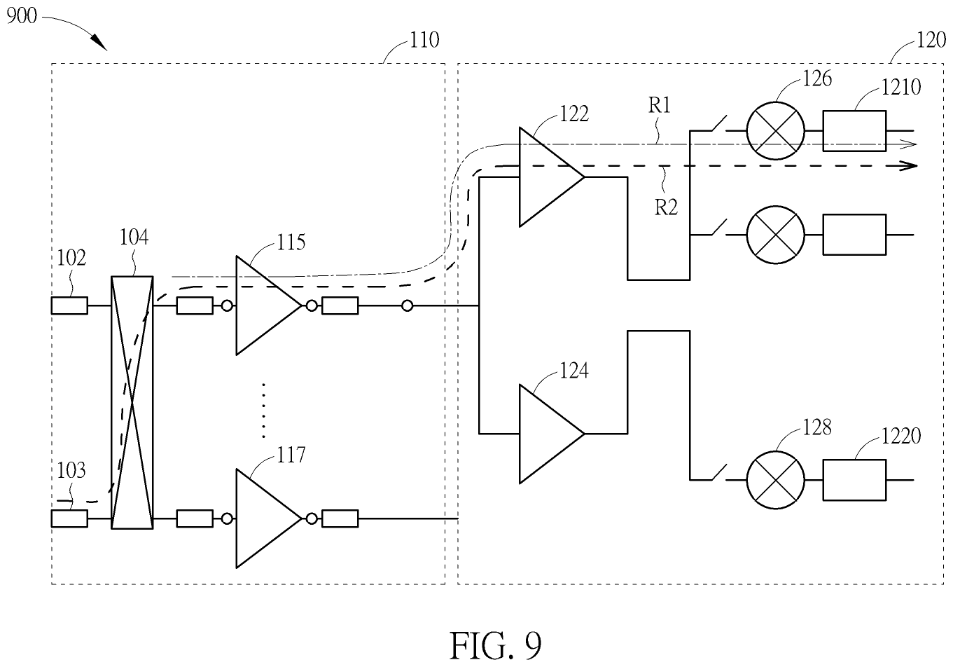

FIG. 9 illustrates a radio-frequency communication device 900 according to another embodiment. The radio-frequency communication device 900 can include a front end circuit 110 and a radio-frequency circuit 120. The front end circuit 110 can include ports 102 and 103, and amplifiers 115 and 117. The radio-frequency circuit 120 can include amplifiers 122 and 124, mixers 126 and 128, and processing circuits 1210 and 1220. The port 102 and the amplifiers 115 and 122 can be on the first route R1. The port 103 and the amplifiers 115 and 122 can be on the second route R2. In FIG. 9, the amplifiers 115 and 117 can be low noise amplifiers (LNAs), and the amplifiers 122 and 124 can be transconductance (gm) amplifiers.

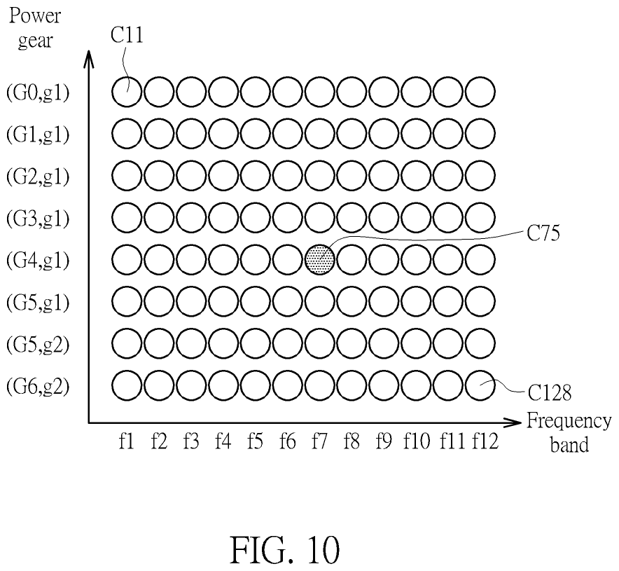

FIG. 10 illustrates m×n conditions of the second route R2 in FIG. 9. In FIG. 10, a condition of an αth frequency band and a βth power gear can be expressed as Cap. For the first route R1 in FIG. 9, all base pathloss values of C11 to C128 can be obtained, for example, measured with an external testing device, as the x base pathloss values in Step S420. For the second route R2 in FIG. 9, the anchor pathloss values of the seventh frequency band f7 and the fifth power gear (G4,g1) can be obtained, for example, measured with an external testing device as the y anchor pathloss values in the Step S430. For example, the anchor pathloss values of the condition C75 can be measured as the y anchor pathloss values in the Step S430. Since the first route R1 and the second route R2 are of different ports (e.g. ports 102 and 103) of the front end circuit 110 and the same path in the radio-frequency circuit 120, the y anchor pathloss values in Step S430 can be of a same frequency band (e.g. the frequency band f7) and a same power gear (e.g. the power gear (G4,g1)). Then, other anchor pathloss values can be derived with the known base pathloss values and anchor pathloss value with the flow of FIG. 4.

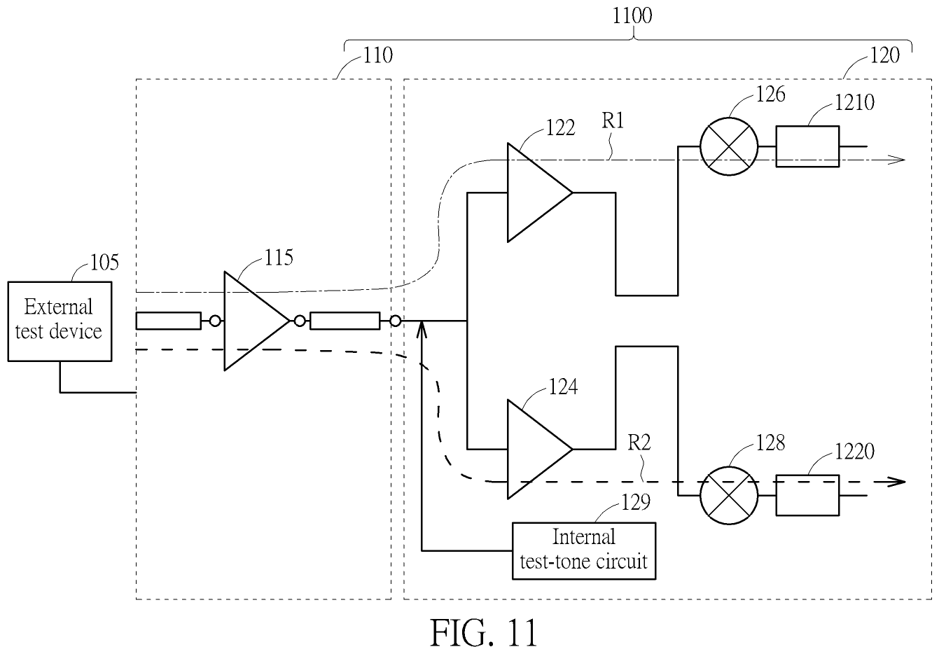

FIG. 11 illustrates a radio-frequency communication device 1100 according to another embodiment. The radio-frequency communication device 1100 can be similar to the radio-frequency communication device 100 in FIG. 1, and an internal test-tone circuit 129 can be further disposed in the radio-frequency circuit 120 of the radio-frequency communication device 1100. The external test device 105 can not be a part of the radio-frequency communication device 1100, and the internal test-tone circuit 129 can be disposed in the radio-frequency communication device 1100.

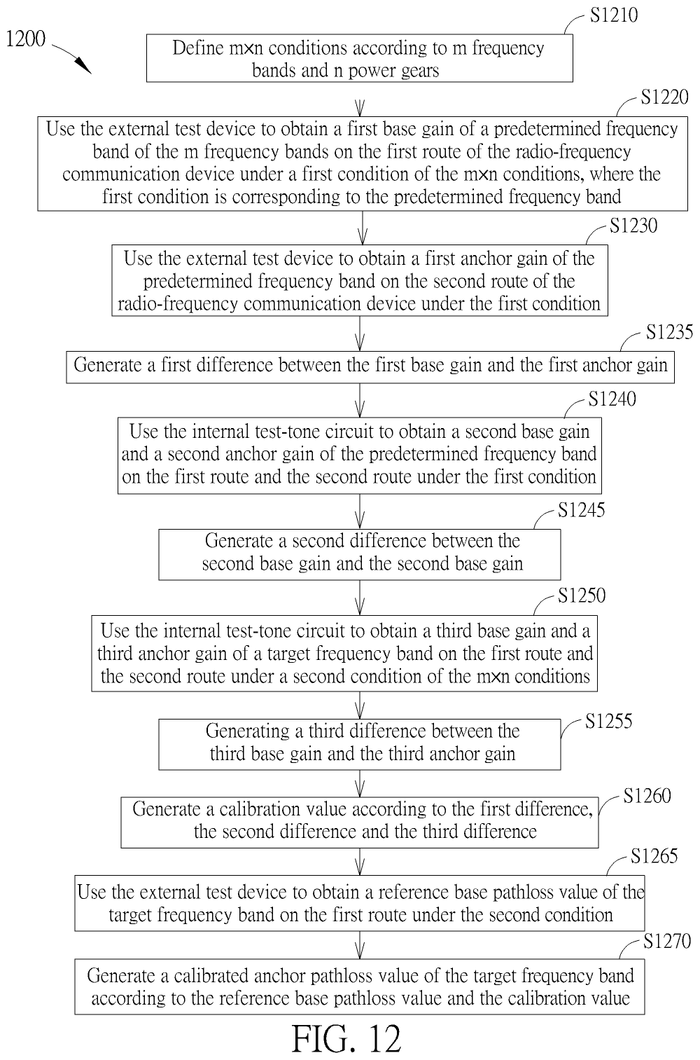

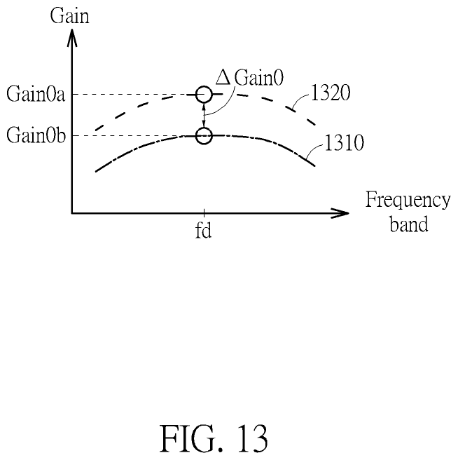

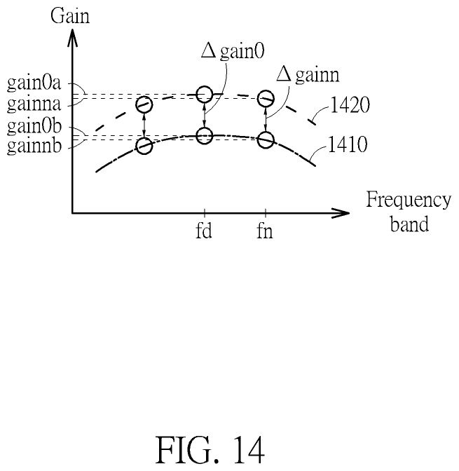

FIG. 12 is a flowchart of a pathloss calibration method 1200 used for the radio-frequency communication device 1100 in FIG. 11. FIG. 13 illustrates a curve 1310 corresponding to gains of the first route R1 and a curve 1320 corresponding to gains of the second route R2 obtained using the external test device 105 in FIG. 11. FIG. 14 illustrates a curve 1410 corresponding to gains of the first route R1 and a curve 1420 corresponding to gains of the second route R2 obtained using the internal test-tone circuit 129 in FIG. 11. As shown in FIG. 11 to FIG. 13, the pathloss calibration method 1200 can include the following steps.

Step S1210: define m×n conditions according to m frequency bands and n power gears;

Step S1220: use the external test device 105 to obtain a first base gain Gain0b of a predetermined frequency band fd of the m frequency bands on the first route R1 of the radio-frequency communication device 1100 under a first condition of the m×n conditions, where the first condition is corresponding to the predetermined frequency band fd;

Step S1230: use the external test device 105 to obtain a first anchor gain Gain0a of the predetermined frequency band fd on the second route R2 of the radio-frequency communication device 1100 under the first condition;

Step S1235: generate a first difference ΔGain0 between the first base gain GainOb and the first anchor gain Gain0a;

Step S1240: use the internal test-tone circuit 129 to obtain a second base gain gain0b and a second anchor gain gain0a of the predetermined frequency band fd on the first route R1 and the second route R2 under the first condition;

Step S1245: generate a second difference Δgain0 between the second base gain gain0b and the second base gain gain0a;

Step S1250: use the internal test-tone circuit 129 to obtain a third base gain gainnb and a third anchor gain gainna of a target frequency band on the first route R1 and the second route R2 under a second condition of the m×n conditions;

Step S1255: generating a third difference Δgainn between the third base gain gainnb and the third anchor gain gainna;

Step S1260: generate a calibration value ΔGain_n_est according to the first difference ΔGain0, the second difference Δgain0 and the third difference Δgainn;

Step S1265: use the external test device to obtain a reference base pathloss value (expressed as Base_PLn) of the target frequency band fn on the first route R1 under the second condition; and

Step S1270: generate a calibrated anchor pathloss value (expressed as Anchor_PLn) of the target frequency band fn according to the reference base pathloss value Base_PLn and the calibration value ΔGain_n_est.

In Step S1260, the calibration value ΔGain_n_est can be equal to a difference of a sum of the first difference ΔGain0 and the third difference Δgainn, and the second difference Δgain0. It can expressed as:

$$\begin{matrix}ΔGain\_n \_est = Δ gainn - ( Δgain0 - ΔGain0 ) \\ = ΔGain 0 + Δ gainn - Δgain0\end{matrix} . \qquad eq - 5$$

In Step S1270, the calibrated anchor pathloss value Anchor_PLn of the second route R2 of FIG. 11 can be derived for saving testing time and cost. The calibrated anchor pathloss value Anchor_PLn of the target frequency band fn can be equal to a difference of the reference base pathloss value Base_PLn and the calibration value ΔGain_n_est generated in Step S1260. It can expressed as:

$$Base\_PLn - ΔGain\_n \_est = Anchor\_PLn . \qquad eq - 6$$

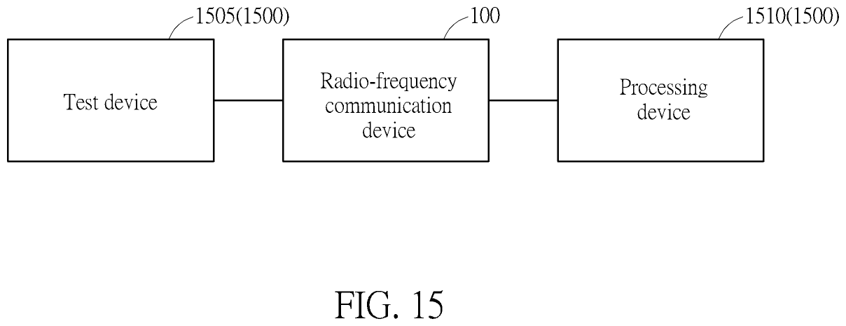

FIG. 15 illustrates a pathloss calibration device 1500 used to perform the pathloss calibration method 400 of FIG. 4. The pathloss calibration device 1500 can include a test device 1505 and a processing device 1510. The test device 1505 can be used to perform Steps S410, S420 and S430 of FIG. 4. The processing device 1510 can be used to perform Steps S440 and S450 of FIG. 4. The test device 1505 can be an external test device which is not a part of the radio-frequency communication device 100. The processing device 1510 can include central processing unit, microprocessor, memory and/or application specific integrated circuit (ASIC). The ASIC can include a filter, an analog-to-digital converter (ADC) and/or a measurement engine.

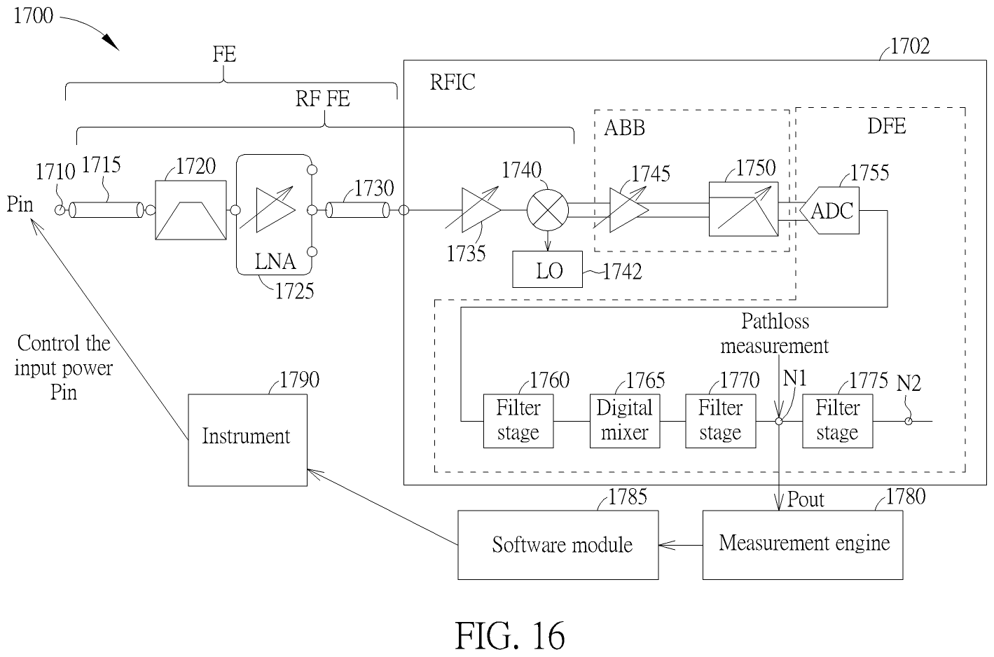

FIG. 16 illustrates a calibration stage structure according to an embodiment. In FIG. 16, an input power Pin can be measured at an antenna port 1710, and an output power Pout can be measured at a node N1. The calibration stage structure 1700 can be used in a reception (RX) chain. The calibration stage structure 1700 can include the antenna port 1710, a printed circuit board (PCB) trace 1715, an low noise amplifier (LNA) 1725, a PCB trance 1730, an LNA 1735, a mixer 1740, an local oscillator (LO) 1742, a transimpedance amplifier (TIA) 1745, a low-pass filter 1750, an ADC 1755, a first filter stage 1760, a digital mixer 1765, a second filter stage 1770, the node N1, a third filter stage 1775, a node N2, a measurement engine 1780, a software module 1785 and an instrument 1790. The measurement engine 1780, the software module 1785 and the instrument 1790 can be used to control the input power Pin according to the result of the pathloss measurement obtained at the node N1.

The software module 1785 can be used to calculate the pathloss. According to an embodiment, the input power Pin can be a known value, and the output power Pout can be measured using the measurement engine 1780. The pathloss and/or gain can be obtained according to the input power Pin and the output power Pout. For different gain gear conditions (e.g. different variable n mentioned above), the input power Pin can be adjusted for calculating the path loss according to the input power Pin and the output power Pout.

As shown in FIG. 16, the antenna port 1710, the PCB trace 1715, the LNA 1725 and the PCB trance 1730 can be of a front end (FE) circuit. The antenna port 1710, the PCB trace 1715, the LNA 1725, the PCB trance 1730, the LNA 1735 and the mixer 1740 can be of a radio-frequency front end (RF FE) circuit. The TIA 1745 and the low-pass filter 1750 can be used for an analog base band (ABB). The ADC 1755, the first filter stage 1760, the digital mixer 1765, the second filter stage 1770, the node N1, the third filter stage 1775 and the node N2 can be used for a digital front end (DFE). The LNA 1735, the mixer 1740, the LO 1742, the TIA 1745, the low-pass filter 1750, the ADC 1755, the first filter stage 1760, the digital mixer 1765, the second filter stage 1770, the node N1, the third filter stage 1775 and the node N2 can be integrated in a chip such as a radio-frequency integrated circuit (RFIC) 1702. In FIG. 16, each of the first filter stage 1760, the second filter stage 1770 and the third filter stage 1775 can include a digital filter, such as a finite-impulse response (FIR) filter.

In FIG. 16, the measurement engine 1780 is not in the RFIC 1702. However, FIG. 16 is an example. In another embodiment, the measurement engine 1780 can be integrated in the RFIC 1702.

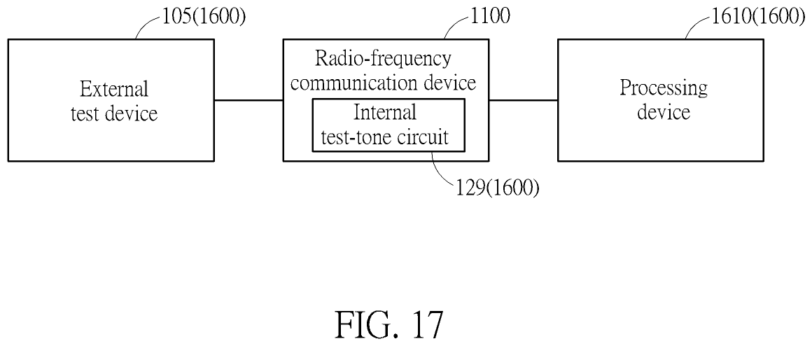

FIG. 17 illustrates a pathloss calibration device 1600 used to perform the pathloss calibration method 1200 in FIG. 12. The pathloss calibration device 1600 can include the external test device 105, the internal test-tone circuit 129 and a processing device 1610. The external test device 105 can be used to perform Steps S1220, S1230 and S1265 of the pathloss calibration method 1200. The internal test-tone circuit 129 can be used to perform Steps S1240 and S1250 of the pathloss calibration method 1200. The processing device 1610 can be used to perform Steps S1235, S1245, S1255, S1260 and S1270.

In summary, through the pathloss calibration method 400, the pathloss calibration method 600, the pathloss calibration method 1200, the pathloss calibration device 1500 and the pathloss calibration device 1600 mentioned above, it is unnecessary to measure the anchor pathloss values of all conditions, and the unmeasured anchor pathloss values can be generated according to the known pathloss values. Hence, time and cost of testing can be effectively reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pathloss calibration method used for a radio-frequency communication device, comprising:
defining m×n conditions according to m frequency bands and n power gears;
obtaining x base pathloss values under x conditions of the m×n conditions on a first route of the radio-frequency communication device;
obtaining y anchor pathloss values under y conditions of the m×n conditions on a second route of the radio-frequency communication device;
generating y offset values according to the y anchor pathloss values and y base pathloss values of the x base pathloss values, where the y base pathloss values are obtained under the y conditions; and
generating z anchor pathloss values on the second route according to the y offset values and the x base pathloss values;
wherein m, n, x, y and z are integers larger than zero, x≤m×n, and x>y.

2. The pathloss calibration method of claim 1, wherein:
each of the y offset values is generated by subtracting a corresponding base pathloss value of the x base pathloss value from a corresponding anchor pathloss value of the y anchor pathloss values; and
the corresponding base pathloss value and the corresponding anchor pathloss value are obtained under a same condition of the m×n conditions.

3. The pathloss calibration method of claim 1, wherein:
the radio-frequency communication device comprises a first amplifier on the first route, and a second amplifier on the second route;
the first amplifier and the second amplifier are operated in a first gear in a first condition of the y conditions;
the first amplifier and the second amplifier are operated in a second gear in a second condition of the y conditions;
a first offset value related to the first condition is used to generate a first group of the z anchor pathloss values related to the first gear; and
a second offset value related to the second condition is used to generate a second group of the z anchor pathloss values related to the second gear.

4. The pathloss calibration method of claim 1, wherein the radio-frequency communication device comprises a low noise amplifier on the first route and the second route, and the low noise amplifier has k gears corresponding to the n power gears, wherein k is an integer larger than zero.

5. The pathloss calibration method of claim 1, wherein:
each of the z anchor pathloss values is generated by adding a corresponding offset value of the y offset values to a corresponding base pathloss value of the x base pathloss values; and
the each of the z anchor pathloss values and the corresponding base pathloss value of the x base pathloss values are related to a same condition of the m×n conditions.

6. The pathloss calibration method of claim 1, further comprising:
obtaining y′ anchor pathloss values under y′ conditions of the m×n conditions on a third route of the radio-frequency communication device;
generating y′ offset values according to the y′ anchor pathloss values and y′ base pathloss values of the x base pathloss values, where the y′ base pathloss values are obtained under the y′ conditions; and
generating z′ anchor pathloss values on the third route according to the y′ offset values and the x base pathloss values;
wherein y′ and z′ are integers larger than zero, and x>y′.

7. The pathloss calibration method of claim 1, wherein an external test device is used to obtain the x base pathloss values and the y anchor pathloss values, and the external test device is not a part of the radio-frequency communication device.

8. The pathloss calibration method of claim 1, wherein:
the radio-frequency communication device comprises a first amplifier, a second amplifier and a third amplifier;
the first amplifier and the second amplifier are on the first route; and
the first amplifier and the third amplifier are on the second route.

9. The pathloss calibration method of claim 8, wherein the first amplifier is a low noise amplifier, the second amplifier and the third amplifier are transconductance amplifiers.

10. The pathloss calibration method of claim 1, wherein:
the radio-frequency communication device comprises a first amplifier, a second amplifier and a third amplifier;
the first amplifier and the second amplifier are on the first route; and
the second amplifier and the third amplifier are on the second route.

11. The pathloss calibration method of claim 10, wherein:
the first amplifier and the third amplifier are low noise amplifiers in a front end circuit of the radio-frequency communication device; and
the second amplifier is a transconductance amplifier in a radio-frequency circuit of the radio-frequency communication device.

12. The pathloss calibration method of claim 10, wherein the y conditions are of a same frequency band of the m frequency bands.

13. The pathloss calibration method of claim 1, wherein:
the radio-frequency comprises:
a front end circuit comprising a first amplifier, a first port, and a second port; and
a radio-frequency circuit comprising a second amplifier;
the first port, the first amplifier and the second amplifier are on the first route; and
the second port, the first amplifier, and the second amplifier are on the second route.

14. The pathloss calibration method of claim 13, wherein the first amplifier is a low noise amplifier, and the second amplifier is a transconductance amplifier.

15. The pathloss calibration method of claim 13, wherein the y conditions of the m×n conditions are of a same frequency band of the m frequency bands and a same power gear of the n power gears.

16. A pathloss calibration method used for a radio-frequency communication device, comprising:
defining m×n conditions according to m frequency bands and n power gears;
using an external test device to obtain a first base gain of a predetermined frequency band of the m frequency bands on a first route of the radio-frequency communication device under a first condition of the m×n conditions, where the first condition is corresponding to the predetermined frequency band;
using the external test device to obtain a first anchor gain of the predetermined frequency band on a second route of the radio-frequency communication device under the first condition;
generating a first difference between the first base gain and the first anchor gain;
using an internal test-tone circuit to obtain a second base gain and a second anchor gain of the predetermined frequency band on the first route and the second route under the first condition;
generating a second difference between the second base gain and the second anchor gain;
using the internal test-tone circuit to obtain a third base gain and a third anchor gain of a target frequency band on the first route and the second route under a second condition of the m×n conditions;
generating a third difference between the third base gain and the third anchor gain;
generating a calibration value according to the first difference, the second difference and the third difference;
using the external test device to obtain a reference base pathloss value of the target frequency band on the first route under the second condition; and
generating a calibrated anchor pathloss value of the target frequency band according to the reference base pathloss value and the calibration value;
wherein the external test device is not a part of the radio-frequency communication device, and the internal test-tone circuit is a part of the radio-frequency communication device.

17. The pathloss calibration method of claim 16, wherein the calibration value is equal to a difference of a sum of the first difference and the third difference, and the second difference.

18. The pathloss calibration method of claim 16, wherein the calibrated anchor pathloss value of the target frequency band is equal to a difference of the reference base pathloss value and the calibration value.

19. A pathloss calibration device, comprising:
an test device configured to define m×n conditions according to m frequency bands and n power gears, obtain x base pathloss values under x conditions of the m×n conditions on a first route of a radio-frequency communication device, and obtain y anchor pathloss values under y conditions of the m×n conditions on a second route of the radio-frequency communication device; and
a processing device configured to:
generate y offset values according to the y anchor pathloss values and y base pathloss values of the x base pathloss values, where the y base pathloss values are obtained under the y conditions; and
generate z anchor pathloss values on the second route according to the y offset values and the x base pathloss values;
wherein m, n, x, y and z are integers larger than zero, x≤m×n, and x>y.

20. A pathloss calibration device, comprising:
an external test device configured to:
measure a first base pathloss value of a predetermined frequency band of the m frequency bands on a first route of a radio-frequency communication device under a first condition of m×n conditions, where the first condition is corresponding to the predetermined frequency band, and the m×n conditions are defined according to m frequency bands and n power gears;
measure a first anchor pathloss value of the predetermined frequency band on a second route of the radio-frequency communication device under the first condition; and
measure a reference base pathloss value of a target frequency band on the first route under a second condition of the m×n conditions;
an internal test-tone circuit configured to:
measure a second base pathloss value and a second anchor pathloss value of the predetermined frequency band on the first route and the second route under the first condition; and
measure a third base pathloss value and a third anchor pathloss value of the target frequency band on the first route and the second route under the second condition; and
a processing device configured to:
generate a first difference between the first base pathloss value and the first anchor pathloss value;
generate a second difference between the second base pathloss value and the second base pathloss value;
generate a third difference between the third base pathloss value and the third anchor pathloss value;
generate a calibration value according to the first difference, the second difference and the third difference; and
generate a calibrated anchor pathloss value of the target frequency band according to the reference base pathloss value and the calibration value;
wherein the external test device is not a part of the radio-frequency communication device, and the internal test-tone circuit is disposed in the radio-frequency communication device.
